(19) United States
(12) Patent Application Publication
(10) Pub. No.: US 2015/0028595 A1
(43) Pub. Date: Jan. 29, 2015

(54) Device For Converting Wave Energy Into Mechanical Energy

(71) Applicant: OXYDICE A/S, Horsens (DK)

(72) Inventor: Tommy Larsen, Ry (DK)

(21) Appl. No.: 14/514,295

(22) Filed: Oct. 14, 2014

Related U.S. Application Data
(63) Continuation of application No. 12/866,418, filed on Nov. 9, 2010, now abandoned.

(30) Foreign Application Priority Data
Feb. 6, 2008 (DK) PA200800166
Jun. 12, 2008 (DK) PA200800812

(51) Int. Cl. F03B 13/18

(52) U.S. Cl. CPC F03B 13/184
USPC 290/53

(57) ABSTRACT

A wave power plant for extracting power from the wave movement of a water surface area, said wave power plant comprising a frame construction in which at least one rotor is journalled, and wherein the rotor is suspended in the frame construction on a rotor shaft which is, in the normal use situation of the wave power plant, essentially horizontal to the effect that the rotor is able to rotate about the rotor shaft which is retained in the frame construction, and wherein means are configured for maintaining each of the rotors partially immersed in a water surface area. The invention provides increased output efficiency of such wave power plant by the rotors being mounted on the rotor shaft via a free-running mechanism which is configured such that the rotor is able to transfer momentum to the rotor shaft essentially only when it rotates the one way about the rotor shaft.

### FIELD OF USE OF THE INVENTION

The present invention relates to a wave power plant for extracting power from the wave movement of a water surface area, said wave power plant comprising a frame construction in which at least one rotor is journalled, and wherein the rotor is suspended in the frame construction on a rotor shaft which is, in the normal use situation of the wave power plant, essentially horizontal to the effect that the rotor is able to rotate about the rotor shaft which is retained in the frame construction, and wherein means are configured for maintaining each of the rotors partially immersed in a water surface area.

### STATE OF THE ART

Today, many different embodiments of wave power plants are known that all share the feature that they utilise the energy which is provided when water is caused to move in a wave movement. A particular category of such wave power plants uses it to advantage that the water at the crest of a wave has a potential energy which is able to drive a rotor in the form of a water mill wheel about an essentially horizontal mill axis when that water is captured in a vane on the one side of the water mill wheel and thus, by means of its body, forces the water mill wheel to rotate. That type of wave power plant excels in being of a relatively simple basic structure with ensuing operational reliability and economy management.

Such plants are known eg from U.S. Pat. Nos. 4,843,249 and 6,551,053 and from GB patent application No. 2110763.

Another type of said wave power plant comprises a number of rotors in the shape of buoyancy bodies that rock in the water surface area under the influence of the waves and thus, by their movement, they convert the kinetic energy in the waves into useful energy.

Examples of such wave power plants are known from eg DK utility model No. 199800152; GB patent No. 1520006; PCT patent application No. WO81/02329; DE patent No. 3904442; DE publication No. 10031310, and PCT application No. 2004/094815.

Examples of the latter wave power plants are known from eg GB patent No. 1541572 and U.S. Pat. No. 3,928,967 and are designated a “Duck”.

It is a constant challenge in the development of wave power plants to optimize the amount of energy that can be extracted from the plant, a commercial penetration of such wave power plants presupposing to a certain extent that, in particular financially, they are able to compete with already existing renewable-energy plants, such as wind turbines and the like.

### OBJECT OF THE INVENTION

It is therefore the object of the present invention to provide a wave power plant of the kind described above and by which an efficient utilisation is provided of the available wave energy.

This is accomplished by a wave power plant of the kind described above and which is characterised in that the rotor is mounted on the rotor shaft via a free-running mechanism which is configured in such a manner that the rotor is able to transfer momentum to the rotor shaft essentially only when it rotates the one way about the rotor shaft.

The present invention is particularly advantageous if, on the rotor shaft, two or more separate rotors are provided that are mounted on a common water mill shaft by means of each their separate free-running mechanism. As it is, the individual rotor is hereby able to pull the rotor shaft around without thereby having to also pull around eg another rotor, which could otherwise, in the opposite event, influence the rotor shaft with an oppositely oriented momentum in some situations when the rotors rotate oppositely relative to each other.

The rotors may comprise two gables between which the parts that cooperate with the wave are configured, such as a number of vanes along the outer periphery of the water mill wheel in the situation when the rotor is a water wheel, and where the distance between the gables is less than two meters and preferably less than 1.5 meters. Hereby, high output efficiency is accomplished for each rotor and hence for the wave power plant.

According to an advantageous embodiment, the frame construction comprises two or more rotor modules, each of which comprises a frame and a rotor shaft, and wherein each of the rotor modules is also provided with retaining means which are configured with a view to mounting the rotor modules to each other in such a manner that the rotor shafts extend in prolongation of each other; and wherein means are configured for interconnection of the rotor shafts for forming a common rotor shaft for two or more of the rotor modules. Hereby a particularly simple construction is provided by which wave power plants can be dimensioned with different dimensions with due regard to the space available and the power output desired from the wave power plant.

The rotors can be mounted such on the rotor shaft that they are separated exclusively by a clearance that allows the two adjacent rotors to rotate freely relative to each other about the rotor shaft. Thereby, all other things being equal, a maximum power output from a wave power plant with a rotor shaft of a given length can be accomplished.

The free-running mechanism may advantageously comprise or be constituted by a ratchet mechanism which allows the rotor to run freely about the rotor shaft in one direction only, but not in the opposite direction in which, in the given case, the rotor would pull the rotor shaft along with it.

It being, by a wave power plant according to the present invention, possible to optimise the extraction of power from the individual rotors and hence also from the total wave power plant, the present invention also provides a method of constructing a wave power plant according to the invention, which method is characterised in that the gables on one or more of the rotors are arranged at a mutual distance from each other which is smaller than the distance between two wave crests and preferably smaller than half of the distance between two wave crests relative to normal operational conditions of the wave power plant.

This enables that a wave power plant can be adapted to normal operational conditions that occur in many different locations where, obviously, water surface areas having waves of very different natures may occur.

### LIST OF FIGURES

FIG. 1 is an explanatory sketch showing an alternative embodiment of a wave power plant according to the present invention, seen straight from the top;

FIG. 2 is a sketch showing a component partaking in the wave power plant shown in FIG. 1, seen in an inclined view from the front;

FIG. 3 is a sketch showing a partaking component in the same manner as in FIG. 2, but wherein the rotors are configured alternatively;

FIG. 4 is a sketch showing a section of the wave power plant shown in FIG. 1, partially immersed in a water surface area and seen from the front;

FIG. 5 is an explanatory sketch showing a cross-section between a free-running mechanism according to the present invention for the water wheel shown in FIG. 4.

### EMBODIMENT OF THE INVENTION

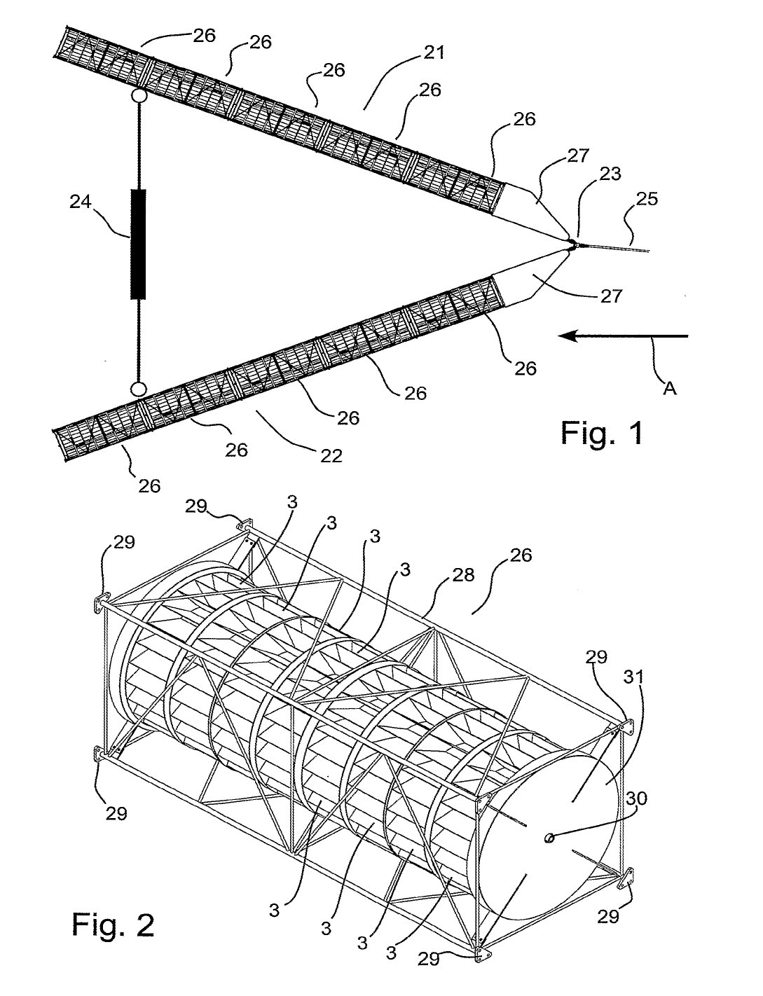

Thus, FIG. 1 shows an embodiment of a wave power plant according to the present invention, which wave power plant is a floating structure floating on the water surface area where waves are present that propagate in the direction of the arrow A. That wave power plant comprises two elongate, separate frame constructions 21, 22 that are hinged to each other via a hinge 23, said hinge also functioning as anchoring point for a mooring 25. Thereby the two separate frame constructions 21, 22 may be arranged according to choice at a mutual angle, and to that end a linear actuator 24 is configured, such as a hydraulic cylinder or a mechanical spindle.

By adjusting the length of the linear actuator 24, the angle between the two separate frame constructions 21, 22 can be adjusted manually or automatically as needed to the effect that the angle can be optimised with a view to obtaining the highest possible output effect or with a view to ensuring against breakdowns in stormy conditions or other.

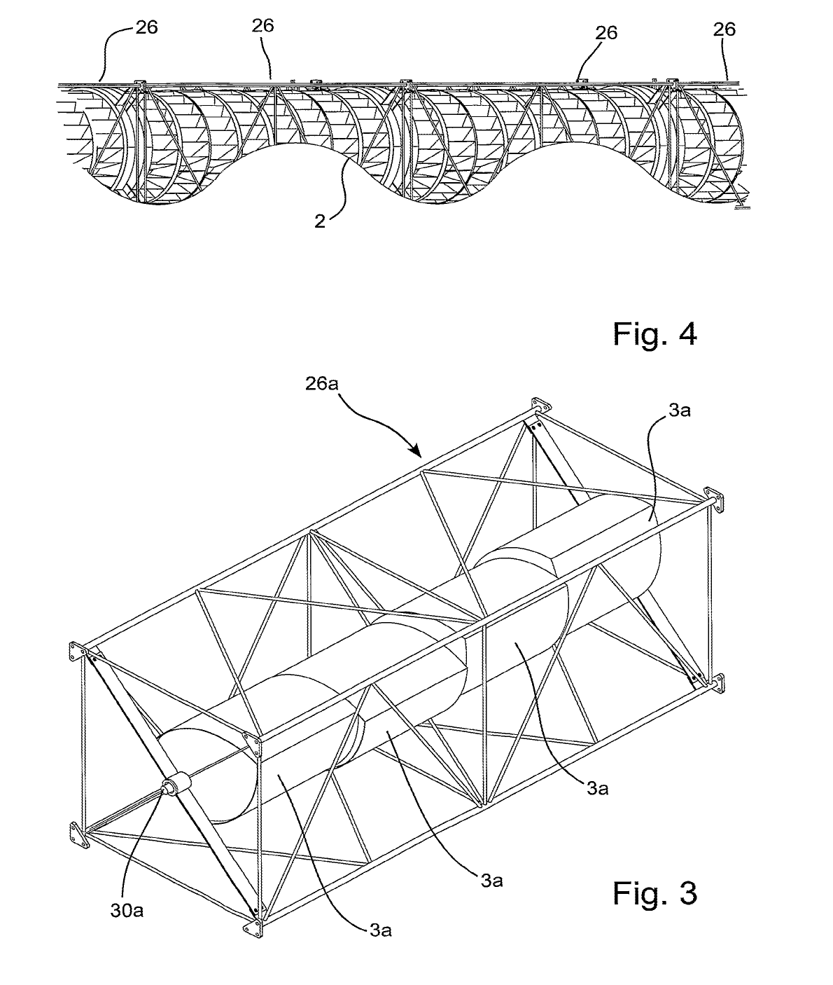

As will appear from FIG. 1, each of the two separate frame constructions is made as an elongate structure comprising a number of rotor modules 26 of which one of such modules is shown in enlarged view in FIG. 2 and in an alternative embodiment in FIG. 3 where another type of rotor is used which will be subject to detailed description below. The rotor modules 26 are assembled in prolongation of each other to the effect that the rotor shafts 30 in the rotor modules 26 are connected to each other in prolongation of each other, and wherein the rotor shaft on the first rotor module 26, seen from the hinge 23, is coupled to an essentially waterproof machine housing 27, in which the rotor shaft is coupled to eg a generator, a pump, a gear or other aggregate that can be driven by the momentum that is transferred to the rotor shaft via all the rotors 3, shown here as water mill wheels, in the separate frame construction 21, 22. Thus, it is possible to configure the machine housing 27 with the components that are needed to extract the energy which, via rotors 3, are transferred to the rotor shaft, and, thus, the wave power plant can be used for generating electric current via eg a generator or for other purposes, such as for pumping a fluid medium by means of a pump.

The person skilled in the art being able to point to many different embodiments of how the rotation and momentum of the rotor shaft can be used for generating useful energy, the figures do not show details of that part of the wave power plant.

According to the invention, all the rotors 3 are connected to the rotor shaft via a ratchet mechanism as shown in FIG. 4. As they are, in the embodiment where the rotor is configured as a water wheel, provided with an abundant amount of vanes or dishes 8 that all face with their opening upwards on the side of the water mill wheels that faces towards the direction of propagation A of the waves, the vanes 8 will be filled with water when the water level rises due to a wave crest passing, and then the water-filled vanes 8 will pull the water mill wheels 3 around when the water level falls following passage by the wave crest of a given vane 8.

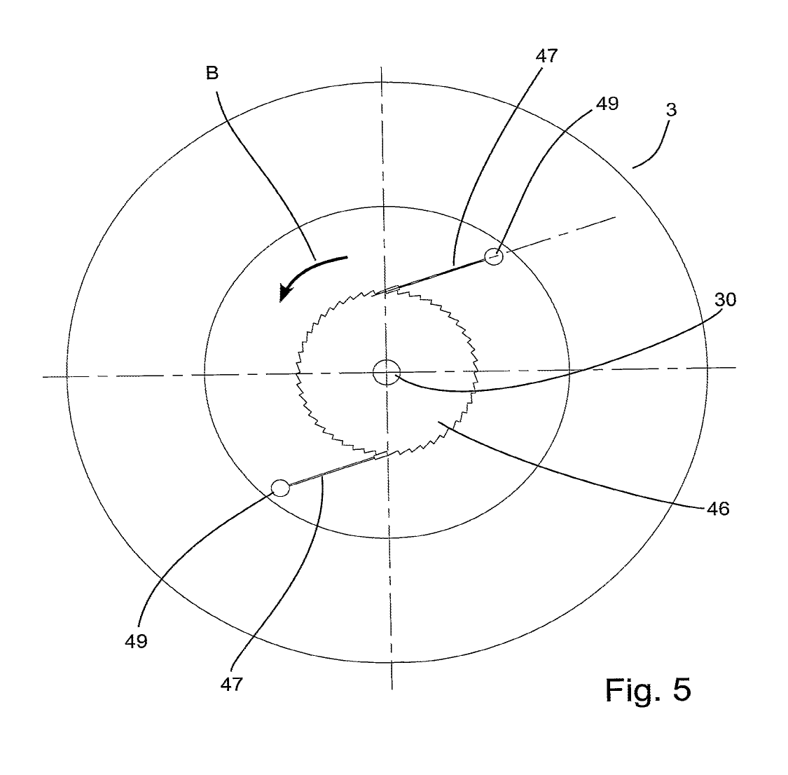

In certain conditions, when another type of rotors is used, such as the ones that are shown in FIG. 3, the waves will, due to their inertia, influence the rotors to rock around the rotor shaft on which they are rotatably mounted, and thereby such rotors will primarily pull the rotor shaft the one way around due to the influence of the waves. In this context, the ratchet mechanism is therefore to be reversed relative to the direction shown in FIG. 5, it having here to allow the rotor to rotate essentially freely in the opposite direction of what is accomplished by the ratchet mechanism shown in FIG. 4. This is not shown specifically as it would be obvious to the person skilled in the art to do so by reversing the constituents partaking in the ratchet mechanism relative to the rotor shaft.

As mentioned, FIG. 3 shows an alternative embodiment of the invention where, instead of water mill wheels as shown in FIG. 3, the mill module 26a comprises a number of rotors 3a that are mounted on a rotor shaft 30a. Each of the rotors has a lift and a shape which are asymmetrical about the rotor shaft 30a to the effect that, when the waves hit the rotor 3a, it is forced to rotate about the rotor shaft 30a and hence to rotate the rotor shaft. This type of rotor is commonly known from eg GB patent No. 1541572 and U.S. Pat. No. 3,928,967 and is designated a “Duck” and has particularly good properties with regard to output efficiency. Additionally, it will be obvious to the person skilled in the art that the present invention as described herein can be used in the context of rotors of various configurations without thereby departing from the fundamental principle on which the invention relies.

Here the wave power plant is configured as a floating structure that can be anchored to eg a seabed underneath the water surface area 2. To that end a mooring point is arranged in the form of an anchorage eyelet in the hinge 23 for retaining a mooring 25. The anchorage eyelet being arranged at that end of the wave power plant where the distance between the rotor shafts is the shortest, this will mean that the wave power plant will be able to turn about its mooring to the effect that it will, at all times, settle in a position that ensures that it utilises the wave energy optimally.

The highest output efficiency for wave power plants of this type is achieved when the water mill wheels 3 are immersed so far into the water surface area that the water mill shaft has essentially the same height as the mean wave height in the water surface 2. In the same manner the rotors shown in FIG. 3 will have maximal output efficiency when they are immersed to a predetermined depth which will depend is on the specific shape of the rotors. However, since it is not always the case that the mean wave height is precisely equal to the mean value of the height of the water level at the wave crest and the wave trough, the invention is configured with a ballast tank 31 and a not shown pump configured in the pump housing 11, and wherein the pump is configured for filling and emptying the ballast tank 31 with water with a view to changing the weight of the wave power plant and/or its lift to the effect that it is possible to optimise the output efficiency of the plant in accordance with the currently prevailing wave conditions.

As will appear from FIG. 4, each of the above-mentioned rotor modules 26 is constituted of a lattice structure 28, and according to the invention a number (herein eight are shown) of separate rotors 3 are provided in the lattice structure 28 and on the rotor shaft 30 which are all mounted on the rotor shaft 30 by means of a separate ratchet mechanism which is shown in detail in FIG. 4. Thereby all of the rotors 3 are able to rotate freely only in one direction relative to the rotor shaft 30 in the lattice structure which, in normal operational conditions using water wheels as rotors as shown in FIG. 3, will entail that some water mill wheels 3 will rotate due to them having water-filled vanes that will pull the water mill wheel around, while other water mill wheels 3 will be at standstill or rotate at a substantially lower rate of rotation due to them being in a position relative to the water level where the vanes are filled with water because the height of the water level 2 is increased prior to the passage of a wave crest past the water mill wheel 3 concerned.

In the situation where “ducks” are used as rotors as it is shown in FIG. 3, the waves with their inertia will instead influence such “ducks” to rotate when they hit the individual “duck” from the front. As a consequence of the wave not hitting all “ducks” at the same time, their rocking movement will obviously be out of step with each other.

The rotor modules 26 constitute a very simple and rigid construction without the lattice structure 28 exercising a significant influence on the waves in the water. The lattice structure is provided with mounting plates 29 at each end of the lattice structure 28 allowing two or more lattice structures 28 to be assembled in prolongation of each other.

The rotor shaft 30 in the rotor module 26 protruding, it is, as mentioned above, possible to assemble the rotor shafts 30 of several rotor modules 26 mounted in prolongation of each other to form a long, assembled rotor shaft that is able to transmit momentum from all the rotors to the engine housing 27.

From FIGS. 2 and 3 it will further appear that the rotor module 26 is provided with ballast tanks 31 that can, via not shown pumps and conduits configured to that end, be filled with or emptied of water to regulate the lift and/or weight of the wave power plant.

Now, FIG. 4 shows a section of one of the separate frame constructions 21, 22 comprising several rotor modules 26 assembled in prolongation of each other and partially immersed in a water surface area 2.

FIG. 5 shows another cross section of the water mill wheel shown in FIG. 4 wherein, in particular, an embodiment of a free-running mechanism is shown, by which a water mill wheel 3 is mounted to the water mill shaft 30. That free-running mechanism is of the ratchet type, it comprising a ratchet wheel 46 which is secured to the water mill shaft 30, and wherein two ratchet latches 47 are secured to the water mill wheel 3 as such at the retaining sites 49, each of which ratchet latches is pressed elastically towards the ratchet wheel 46 to the effect that the water mill wheel is able to rotate exclusively in the direction of the arrow B. This free-running mechanism distinguishes itself by being comparatively maintenance-free relative to other free-running mechanisms, which is a major advantage in the working environment of a wave power plant.

In this context, it is obvious, as mentioned above, that other rotor types, such as the “ducks” that are shown in FIG. 3 will be able to primary pull the rotor shaft the opposite way around and, as mentioned, that would presuppose that the ratchet mechanism is turned such that it allows free-running in the direction opposite that which was obtained by the device of FIG. 5.

1. A wave power plant for extracting power from the wave movement of a water surface area, said wave power plant comprising a frame construction in which at least one rotor is journalled, and wherein the rotor is suspended in the frame construction on a rotor shaft which is, in the normal use situation of the wave power plant, essentially horizontal to the effect that the rotor is able to rotate about the rotor shaft which is retained in the frame construction, and wherein means are configured for maintaining each of the rotors partially immersed in a water surface area, characterised in that the rotor is mounted on the rotor shaft via a free-running mechanism which is configured in such a manner that the rotor is able to transfer momentum to the rotor shaft essentially only when it rotates the one way about the rotor shaft.

2. A wave power plant according to claim 1, characterised in that, on the rotor shaft, two or more separate rotors are configured that are mounted on a common rotor shaft by means of each their separate free-running mechanism.

3. A wave power plant according to claim 2, characterised in that each rotor comprises two gables, and wherein the distance between the gables on the rotors is less than 2 meters and preferably less than 1.5 meters.

4. A wave power plant according to claim 3, characterised in that the frame construction comprises two or more rotor modules that each comprises a frame and a rotor shaft, and wherein each of the rotor modules is also provided with retaining means that are configured with a view to mounting the rotor modules to each other in such a manner that the rotor shafts extend in prolongation of each other; and wherein means are provided for interconnecting the rotor shafts to form a common rotor shaft for two or more of the rotor modules.

5. A wave power plant according to claim 4, characterised in that the gables of two or more rotors are separated exclusively by a clearance that precisely allows the two adjacent water mill Wheels to rotate freely relative to each other about the rotor shaft.

6. A wave power plant according to one or more of the preceding claims, characterised in that the free-running mechanism comprises a ratchet mechanism that allows the rotor to rotate about the rotor shaft in one direction only and not in the opposite direction.

7. A method of constructing a wave power plant according to one or more of the preceding claims, characterised in that the gables on one or more of the rotors are arranged at a mutual distance that is smaller than the distance between two wave crests and preferably smaller than half of the distance between two wave crests relative to operational conditions that are normal to the wave power plant.
